(19) United States
(12) Patent Application Publication
(10) Pub. No.: US 2010/0161153 A1
(43) Pub. Date: Jun. 24, 2010

(54) METHOD AND APPARATUS FOR AUTOMATICALLY DETERMINING STOPOVER AIRPORTS FOR FLIGHT PLANNING

(75) Inventor: Steven D. CORFMAN, Severna Park, MD (US)

Correspondence Address: PRASS LLP, 2661 Riva Road, Bldg. 1000, Suite 1044, ANNAPOLIS, MD, 21401, US

(73) Assignee: ARINC INCORPORATED, Annapolis, MD (US)

(21) Appl. No.: 12/342,121

(22) Filed: Dec. 23, 2008

(51) Int. Cl. G06F 17/00

(52) U.S. Cl. 701/3

(57) ABSTRACT

A method and apparatus that automatically selects one or more stopover airports (or “technical stops”) for flight planning is disclosed. The method may include receiving flight origin, destination, aircraft identification information, aircrew identification information, passenger identification information, and user preference information from a user, receiving weather, safety-of flight and meteorological information based on at least the received origin and destination information, retrieving aircraft information, origin and destination airport information, potential stopover airport information, aircrew information, and passenger information from one or more databases based on at least one of the received flight origin, destination, aircraft identification information, aircrew information, passenger information, and user preference information, automatically selecting one or more stopover airports based on the received weather, safety-of flight and meteorological information and the retrieved flight origin, destination, aircraft information, aircrew information, passenger information, and user preference information, and outputting the selected one or more stopover airports to the user.

### BACKGROUND OF THE DISCLOSURE

1. Field of the Disclosure

The disclosure relates to aircraft flight planning.

2. Introduction

A flight planning system is defined as a tool that will provide information about a specific flight to a pilot and other responsible or relevant parties. The primary output of any flight plan is the route-of-flight (using Highways in the Sky, for example), the time it will take to make the flight, and the fuel required to make the trip. The flight plan may include the actual amount of fuel to be consumed, plus the taxi fuel and any extra or reserve fuel.

Often, a flight plan may require a stopover (or “technical stop”) at an airport in between the origin and destination points. The reasons for a stopover may include aircraft range, weather, Air Traffic Control (ATC) regulation, political regulation, financial, crew licensing and certification, aircraft equipment, airport equipment, etc. These reasons may apply to one or more of the airport, aircraft, crew or passengers, and airspace. However, conventional flight planning systems do not have the ability to automatically determine stopover airports based on the various causes for a stopover, or the user's preferences.

### SUMMARY OF THE DISCLOSURE

A method and apparatus that automatically determines one or more stopover airports (or “technical stops”) for flight planning is disclosed. The method may include receiving flight origin, destination, aircraft identification information, aircrew identification information, passenger identification information, and user preference information from a user, receiving weather, safety-of flight and meteorological information based on at least the received origin and destination information, retrieving aircraft information, origin and destination airport information, potential stopover airport information, aircrew information, and passenger information from one or more databases based on at least one of the received flight origin, destination, aircraft information, aircrew information, passenger information, and user preference information, automatically selecting one or more stopover airports based on the received weather, safety-of flight and meteorological information and the retrieved flight origin, destination, aircraft information, aircrew information, passenger information, and user preference information, and outputting the selected one or more stopover airports to the user.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary diagram of a flight planning system in accordance with a possible embodiment of the disclosure;

FIG. 2 illustrates a block diagram of an exemplary stopover planning unit in accordance with a possible embodiment of the disclosure; and

FIG. 3 illustrates an exemplary automated stopover planning process in accordance with a possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure.

This disclosed embodiments may concern a method and apparatus for automatically determining the need for a stopover (or “technical stop” as may be known to one of skill in the art), and if determined to be necessary, the optimal stops the between the departure airport and the destination airport. To be considered optimal, consideration must be given to several aspects of the flight and how they interact, including aircraft, aircrew, passengers, airports, and enroute airspace. The various sets of data required may be stored in such a way as to allow an automated or semi-automated system to determine the optimal and sub-optimal (ranked) stopover airports and routings to be used to reach the ultimate destination.

An example set of factors to be considered in the analysis:
Aircraft considerations: Aircraft range, aircraft equipment (including equipment that is installed, but may not be working), levels of capability and certification for operation in various enroute and terminal environments, country of manufacture and country of registry, etc.
Aircrew considerations: Licensing, certification, political documentation, criminal record, etc.
Passenger (and or cargo) considerations: Political documentation, criminal record, etc.
Airport considerations: Available fuel, crash and rescue equipment, runway and apron characteristics, weather and weather reporting, navigational approaches and departures, landing and departure fees, customs and immigration, suitable ground handling agents, physical location, services available at time of arrival and departure, parking space, area amenities, currency exchange rates, etc.
Enroute considerations: Airspace fees, navigational capabilities, permits and other “navigation” fees, political considerations (for example, some aircraft types are not allowed in certain country's airspace), time of flight (both “crossing” time and arrival time in the airspace).

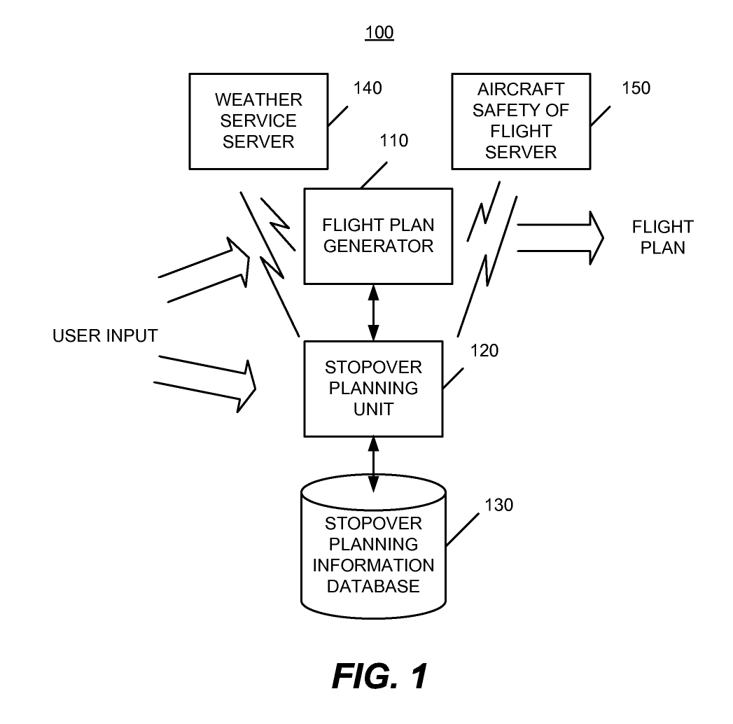

FIG. 1 illustrates an exemplary diagram of a flight planning system 100 in accordance with a possible embodiment of the disclosure. The flight planning system 100 may include flight plan generation 110, stopover planning unit 120, stopover planning information database 130, weather service server 140, and aircraft safety-of-flight server 150.

The flight plan generator 110 may be any system that generates and outputs flight plans to users. The user may input information to the flight plan generator 110 and the stopover planning unit 120, including flight origin, destination, aircraft identification information, aircrew identification information, passenger identification information, and user preference information, for example. Note that while the stopover planning unit 120 is shown to be a separate unit from the flight plan generator 110, the stopover planning unit 120 may be part of a flight plan generator or flight plan generating system. In any case, according at least one of the disclosed embodiments, the flight plan generator 110 receives input from at least the stopover planning unit 120, weather service server 140, and aircraft safety-of-flight server 150.

Weather service server 140 may represent any server that provides weather service information and meteorological data and products, including winds and temperatures aloft, radar, wind shear, thunderstorms, and turbulence information, SIGMETS, AIRMETS, etc., for example. Aircraft safety-of-flight server 150 may represent any server that may provide aviation-related documents, data and products related to safety-of-flight issues, such as NOTAMS, aircraft performance data, navigation data, restricted areas, radio frequency information, enroute charts, approach plates, FAA notices, restricted airspace information, etc., for example

The stopover planning information database 130 may be coupled to the stopover planning unit 120 and may store a plurality of aviation-related documents, data, aircraft information, aircrew information, passenger information, and potential stopover airport information. Aircraft information may include information concerning aircraft range, aircraft equipment, aircraft capability, navigational capabilities, and aircraft certification for operation in various enroute and terminal environments, country of manufacture, and country of registry, for example. Aircrew information may include licensing, certification, political documentation, and criminal record information, for example.

Passenger information may include political documentation, passport information, and criminal record information, for example. Potential stopover airport information may include available fuel, crash and rescue equipment, runway and apron characteristics, weather and weather reporting, navigational approaches and departures, landing and departure fees, customs and immigration, number and type of ground handling agents, physical location, services available at time of arrival and departure, parking space, area amenities, and currency exchange rates, for example.

The components of the flight planning system 100 may be hardwired or wireless and may communicate through any communications network, which may include the Internet, an intranet, telephone, wireless telephone, satellite, a VHF radio network, a SATCOM network, etc.

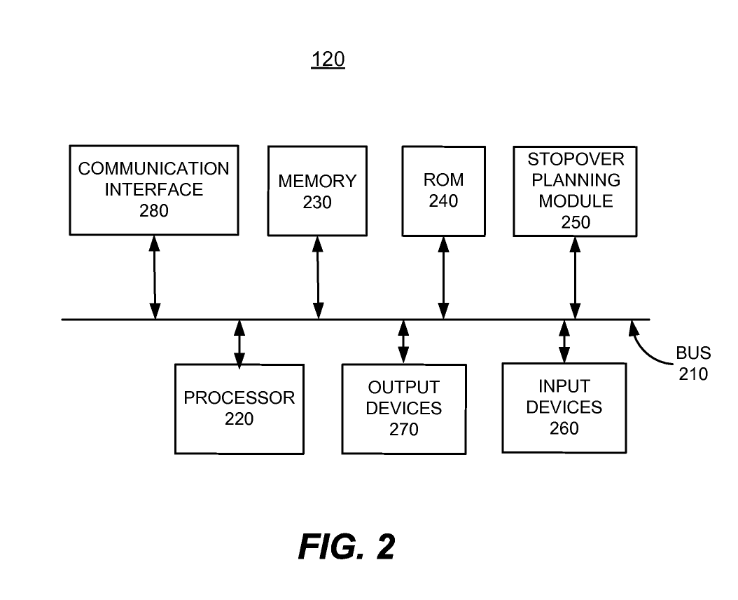

FIG. 2 illustrates a block diagram of an exemplary stopover planning unit 120 in accordance with a possible embodiment of the disclosure. As shown, the stopover planning unit 120 may include a bus 210, a processor 220, a memory 230, a read only memory (ROM) 240, a stopover planning module 250, input devices 260, output devices 270, and a communication interface 280. Bus 210 may permit communication among the components of the stopover planning unit 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also include a storage device which may include any type of media, such as, for example, magnetic or optical recording media and its corresponding drive.

Input devices 260 may include one or more conventional mechanisms or user interface that permit a user to input information to the stopover planning unit 120, such as a keyboard, a mouse, a pen, a voice recognition device, etc. Output devices 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the stopover planning unit 120 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the stopover planning unit 120, communication interface 280 may not be included in the exemplary the stopover planning unit 120 when the stopover planning process is implemented completely within the stopover planning unit 120.

The stopover planning unit 120 may perform such functions in response to processor 220 by executing sequences of instructions contained in a computer-readable medium, such as, for example, memory 230, a magnetic disk, or an optical disk. Such instructions may be read into memory 230 from another computer-readable medium, such as a storage device or from a separate device via communication interface 280.

The stopover planning unit 120 illustrated in FIGS. 1-2 and the related discussion are intended to provide a brief, general description of a suitable computing environment in which the disclosure may be implemented. Although not required, the disclosure will be described, at least in part, in the general context of computer-executable instructions, such as program modules, being executed by the stopover planning unit 120, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

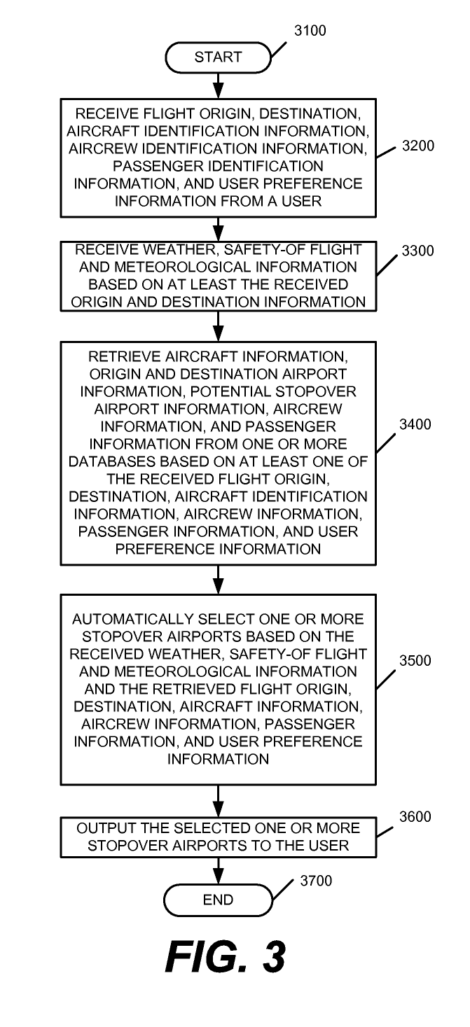

For illustrative purposes, operation of the stopover planning module 250 and the stopover planning process will be described below in FIG. 3 in relation to the block diagrams shown in FIGS. 1-2.

FIG. 3 is an exemplary flowchart illustrating the stopover planning process in accordance with a possible embodiment of the disclosure. The process begins at step 3100 and continues to step 3200 where the stopover planning module 250 may receive flight origin, destination, aircraft identification information, aircrew identification information, passenger identification information, and user preference information from a user.

At step 3300, the stopover planning module 250 may receive weather, safety-of flight and meteorological information based on at least the received origin and destination information through the communication interface.

At step 3400, the stopover planning module 250 may retrieve aircraft information, origin and destination airport information, potential stopover airport information, aircrew information, and passenger information from one or more databases based on at least one of the received flight origin, destination, aircraft identification information, aircrew information, passenger information, and user preference information.

At step 3500, the stopover planning module 250 may automatically select one or more stopover airports based on the received weather, safety-of flight and meteorological information and the retrieved flight origin, destination, aircraft information, aircrew information, passenger information, and user preference information. The number of stopover airports needed to complete the flight may vary based on user preferences, time of the flight (quiet hours at airports).

At step 3600, the stopover planning module 250 may output the selected one or more stopover airports to the user. The process may then go to step 3700 and end.

The stopover planning module 250 may prompt the user to confirm the selection of the one or more of the selected stopover airports and receive the user's confirmation of the one or more selected stopover airports. Otherwise, if the user rejects the selected one or more stopover airport, the stopover planning module 250 may select another one or more stopover airport.

Alternatively, the stopover planning module 250 may rank one or more of the selected stopover airports in a list based on the received weather, safety-of flight and meteorological information and the retrieved flight origin, destination, aircraft identification information, aircrew information, passenger information, and user preference information, present the ranked list to the user, prompt the user to select one or more stopover airports from the presented list, receive the user's selection of the one or more selected stopover airports from the presented list, and output a flight plan that includes the user's selected one or more selected stopover airports.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components of the disclosed embodiments each processing the content in various possible ways. It does not necessarily need to be one system used by all end users. Accordingly, the appended claims and their legal equivalents should only define the disclosure, rather than any specific examples given.

We claim:

1. A method for automatically selecting one or more stopover airports for flight planning, comprising:
receiving flight origin, destination, aircraft identification information, aircrew identification information, passenger identification information, and user preference information from a user;
receiving weather, safety-of flight and meteorological information based on at least the received origin and destination information;
retrieving aircraft information, origin and destination airport information, potential stopover airport information, aircrew information, and passenger information from one or more databases based on at least one of the received flight origin, destination, aircraft information, aircrew information, passenger information, and user preference information;
automatically selecting one or more stopover airports based on the received weather, safety-of flight and meteorological information and the retrieved flight origin, destination, aircraft identification information, aircrew information, passenger information, and user preference information; and
outputting the selected one or more stopover airports to the user.

2. The method of claim 1, further comprising:
prompting the user to confirm the selection of the one or more of the selected stopover airports; and
receiving the user's confirmation of the one or more selected stopover airports, otherwise
selecting another one or more stopover airport.

3. The method of claim 1, further comprising:
ranking one or more of the selected stopover airports in a list based on the received weather, safety-of flight and meteorological information and the retrieved flight origin, destination, aircraft identification information, aircrew information, passenger information, and user preference information;
presenting the ranked list to the user;
prompting the user to select one or more stopover airports from the presented list;
receiving the user's selection of the one or more selected stopover airports from the presented list; and
outputting a flight plan that includes the user's selected one or more selected stopover airports.

4. The method of claim 1, wherein user preferences include at least one of avoid turbulence, fly over a particular point of interest, avoid certain altitudes, fly at maximum range, fly at maximum fuel economy, fly to achieve fastest time, and minimize airport fees.

5. The method of claim 1, wherein the metrological information includes at least one of winds aloft, radar, lightning reports, clear air turbulence reports, SIGMETs, AIRMETs, and wind shear reports.

6. The method of claim 1, wherein the safety-of-flight information includes at least one-of aviation-related documents, aircraft performance data, navigation data, restricted areas, and NOTAMs.

7. The method of claim 1, wherein aircraft information includes at least one of aircraft range, aircraft equipment, aircraft capability, navigational capabilities, aircraft certification for operation in various enroute and terminal environments, country of manufacture, and country of registry.

8. The method of claim 1, wherein aircrew information includes at least one of licensing, certification, political documentation, and criminal record information.

9. The method of claim 1, wherein passenger information includes at least one of political documentation, passport information, and criminal record information.

10. The method of claim 1, wherein potential stopover airport information includes at least one of available fuel, crash and rescue equipment, runway and apron characteristics, weather and weather reporting, navigational approaches and departures, landing and departure fees, customs and immigration, number and type of ground handling agents, physical location, services available at time of arrival and departure, parking space, area amenities, and currency exchange rates.

11. A stopover planning unit that automatically selects one or more stopover airports for flight planning, comprising:
a communication interface; and
a stopover planning module that receives flight origin, destination, aircraft identification information, aircrew identification information, passenger identification information, and user preference information from a user, receives weather, safety-of flight and meteorological information based on at least the received origin and destination information through the communication interface, retrieves aircraft information, origin and destination airport information, potential stopover airport information, aircrew information, and passenger information from one or more databases based on at least one of the received flight origin, destination, aircraft identification information, aircrew information, passenger information, and user preference information, automatically selects one or more stopover airports based on the received weather, safety-of flight and meteorological information and the retrieved flight origin, destination, aircraft information, aircrew information, passenger information, and user preference information, and outputs the selected one or more stopover airports to the user.

12. The stopover planning unit of claim 11, wherein the stopover planning module prompts the user to confirm the selection of the one or more of the selected stopover airports, and receives the user's confirmation of the one or more selected stopover airports, otherwise the stopover planning module selects another one or more stopover airport.

13. The stopover planning unit of claim 11, wherein the stopover planning module ranks one or more of the selected stopover airports in a list based on the received weather, safety-of flight and meteorological information and the retrieved flight origin, destination, aircraft identification information, aircrew information, passenger information, and user preference information, presents the ranked list to the user, prompts the user to select one or more stopover airports from the presented list, receives the user's selection of the one or more selected stopover airports from the presented list, and outputs a flight plan that includes the user's selected one or more selected stopover airports.

14. The stopover planning unit of claim 11, wherein user preferences includes at least one of avoid turbulence, fly over a particular point of interest, avoid certain altitudes, fly at maximum range, fly at maximum fuel economy, fly to achieve fastest time, and minimize airport fees.

15. The stopover planning unit of claim 11, wherein the metrological information includes at least one of winds aloft, radar, lightning reports, clear air turbulence reports, SIGMETs, AIRMETs, and wind shear reports.

16. The stopover planning unit of claim 11, wherein the safety-of-flight information includes at least one-of aviation-related documents, aircraft performance data, navigation data, restricted areas, and NOTAMs.

17. The stopover planning unit of claim 11, wherein aircraft information includes at least one of aircraft range, aircraft equipment, aircraft capability, navigational capabilities, and aircraft certification for operation in various enroute and terminal environments, country of manufacture, and country of registry.

18. The stopover planning unit of claim 11, wherein aircrew information includes at least one of licensing, certification, political documentation, and criminal record information.

19. The stopover planning unit of claim 11, wherein passenger information includes at least one of political documentation, passport information, and criminal record information.

20. The stopover planning unit of claim 11, wherein potential stopover airport information includes at least one of available fuel, crash and rescue equipment, runway and apron characteristics, weather and weather reporting, navigational approaches and departures, landing and departure fees, customs and immigration, number and type of ground handling agents, physical location, services available at time of arrival and departure, parking space, area amenities, and currency exchange rates.

21. A computer-readable medium storing instructions for automatically selecting one or more stopover airports for flight planning, the instructions comprising:
receiving flight origin, destination, aircraft identification information, aircrew identification information, passenger identification information, and user preference information from a user;
receiving weather, safety-of flight and meteorological information based on at least the received origin and destination information;
retrieving aircraft information, origin and destination airport information, potential stopover airport information, aircrew information, and passenger information from one or more databases based on at least one of the received flight origin, destination, aircraft identification information, aircrew information, passenger information, and user preference information;
automatically selecting one or more stopover airports based on the received weather, safety-of flight and meteorological information and the retrieved flight origin, destination, aircraft information, aircrew information, passenger information, and user preference information; and
outputting the one or more stopover airports to the user.
